(19) United States
(12) Patent Application Publication
(10) Pub. No.: US 2025/0211858 A1
(43) Pub. Date: Jun. 26, 2025

(54) MULTIFUNCTION DRIVER ASSIST SIDE CAMERA

(71) Applicants: Gert Edzko SMID, Oxford, MI (US); John Robert Scott MITCHELL, Thornton (CA)

(72) Inventors: Gert Edzko SMID, Oxford, MI (US); John Robert Scott MITCHELL, Thornton (CA)

(21) Appl. No.: 18/845,057

(22) PCT Filed: Mar. 7, 2023
(86) PCT No.: PCT/US2023/014688

§ 371 Date: Sep. 9, 2024

Related U.S. Application Data
(60) Provisional application No. 63/318,143, filed on Mar. 9, 2022.

(51) Int. Cl. H04N 23/695; B60R 1/06; B60R 1/12; B60R 16/02; H04N 23/51; H04N 23/55

(52) U.S. Cl. CPC H04N 23/695; B60R 1/06; B60R 1/12; B60R 16/0207; H04N 23/51; H04N 23/55; B60R 2001/1253

(57) ABSTRACT

An exterior vehicle component includes an exterior mirror, a camera, and a lens array. The lens array includes a first optical element and a second optical element, each providing a different field-of-view. At least one of the camera or the lens array is movable relative to the other one of the camera and the lens array to align the camera with a corresponding one of the first optical element or the second optical element. One of the optical elements includes a fisheye lens, and the other one of the optical elements includes a prism.

### CROSS REFERENCE TO RELATED APPLICATIONS

This PCT International Patent application claims the benefit of and priority to U.S. Provisional Patent Application Ser. No. 63/318,143, filed Mar. 9, 2022, titled “Multifunction Driver Assist Side Camera,” the entire disclosure of which is hereby incorporated by reference.

### FIELD

The present disclosure relates generally to vehicle-mounted cameras. More specifically, the present disclosure relates to a camera for automotive ADAS applications.

### BACKGROUND

Traditional surround-view systems may include a camera inside of an exterior mirror of a vehicle, with the camera mounded having a downward-facing view with a field of view of approximately 180-degrees.

### SUMMARY

The present disclosure provides an exterior vehicle component. The exterior vehicle component comprises a camera, and a lens array. The lens array includes a first optical element and a second optical element, each providing a different field-of-view. At least one of the camera or the lens array is movable relative to the other one of the camera and the lens array to align the camera with a corresponding one of the first optical element or the second optical element.

### BRIEF DESCRIPTION OF THE DRAWINGS

Further details, features and advantages of designs of the invention result from the following description of embodiment examples in reference to the associated drawings.

FIG. 1 shows an overhead view of a vehicle with coverage of various cameras, according to an aspect of the present disclosure;

FIG. 2 shows a forward-facing view including an exterior mirror housing with partial transparency to illustrate components of a first camera assembly of the present disclosure;

FIG. 3 shows a side-facing view including an exterior mirror housing with partial transparency to illustrate components of a second camera assembly of the present disclosure;

FIG. 4 shows a side-facing view including an exterior mirror housing with partial transparency to illustrate components of a third camera assembly of the present disclosure;

FIG. 5 shows a schematic diagram of a camera viewing profile when aligned with a prism optical element; and

FIG. 6 shows a schematic diagram of a camera viewing profile when aligned with a fisheye optical element.

### DETAILED DESCRIPTION

Referring to the drawings, the present invention will be described in detail in view of following embodiments.

The present disclosure provides a camera mounted inside an exterior side mirror housing of a vehicle, such as a passenger car or truck. The camera may be used for advanced driver assistance (ADAS) applications. The camera may capture images of a surrounding of the vehicle, which may be presented to the driver through one or more interfaces. Alternatively or additionally, the camera may be used as a data source for a machine vision system to sense the surroundings of the vehicle. The system of the present disclosure includes exchangeable optics in order to support multiple ADAS features.

The camera is may be mounted such that the viewing direction is facing downwards. The optics includes a PRISM, which re-directs the viewing angle forward and/or backward relative to the vehicle orientation, and it furthermore includes a FISHEYE lens to increase the viewing field-of-view (FOV) to approx. 180 deg. Either one of the optical elements can be mechanically moved in front of the camera, or the camera can be moved across to align with the optical elements. Using an 8 mega-pixel (MP) camera, the system of the present disclosure can cover the necessary resolution for surround view applications, when aligned with the FISHEYE element. Using a single PRISM optical element will provide a split screen image combining front and rear view in a single image. The width of the view will be double the height of the view in the image plane.

The system of the present disclosure may provide several advantages over conventional camera systems. It can provide a cost savings by reducing the number of cameras used to provide a given set of fields of view. It can provide additional cost savings and reduction in complexity by reducing computing resources and cabling associated with the cameras.

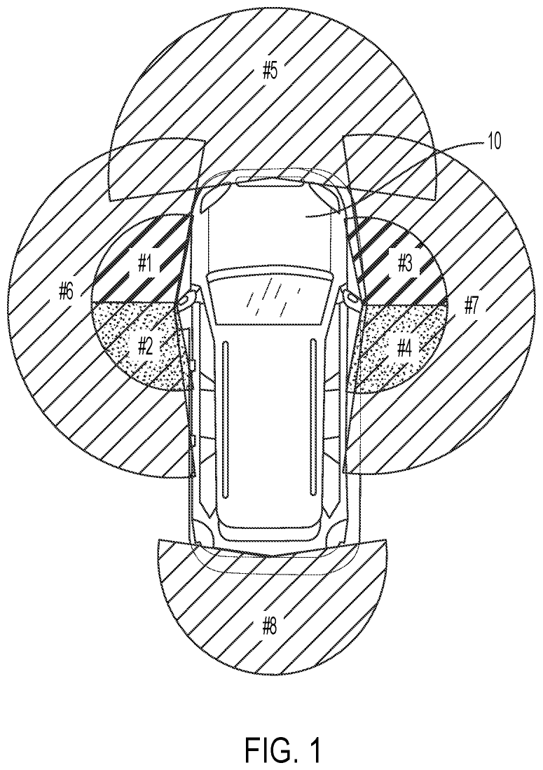

FIG. 1 shows an overhead view of a vehicle 10 with coverage of various cameras. FIG. 1 shows various cameras providing the following different fields-of-view (FOV) as listed in Table 1:

TABLE 1

| No. | Location | Function | Resolution | FOV Angle |
|---|---|---|---|---|
| #1 | Outside Mirror/ | ADAS Side LH 1 | 8 MP | 100 deg. |
| | Applique | | | |
| | (Left Side, | | | |
| | Forward) | | | |
| #2 | Outside Mirror/ | ADAS Side LH 2/ | 8 MP | 100 deg. |
| | Applique | CMS LH Rear | | |
| | (Left Side, | | | |
| | Rear) | | | |
| #3 | Outside Mirror/ | ADAS Side RH 1 | 8 MP | 100 deg. |
| | Applique | | | |
| | (Right Side, | | | |
| | Forward) | | | |
| #4 | Outside Mirror/ | ADAS Side RH 2/ | 8 MP | 100 deg. |
| | Applique | CMS RH Rear | | |
| | (Right Side, | | | |
| | Rear) | | | |
| #5 | Grille | Surround Camera 1 | 5 MP | 195 deg. |
| #6 | Outside Mirror/ | Surround Camera 2 | 5 MP | 195 deg. |
| | A-Pillar | | | |
| | (Left Side, | | | |
| | Aimed Down) | | | |
| #7 | Outside Mirror/ | Surround Camera 3 | 5 MP | 195 deg. |
| | A-Pillar | | | |
| | (Right Side, | | | |
| | Aimed Down) | | | |
| #8 | Rear Light Bar/ | Surround Camera 4 | 5 MP | 195 deg. |
| | Rear Handle/ | | | |
| | Rear Applique | | | |

The image data from the cameras may be provided to one or more controllers or processors, which may use the image data therefrom to provide ADAS functions, such as Level-3 (L3) automation.

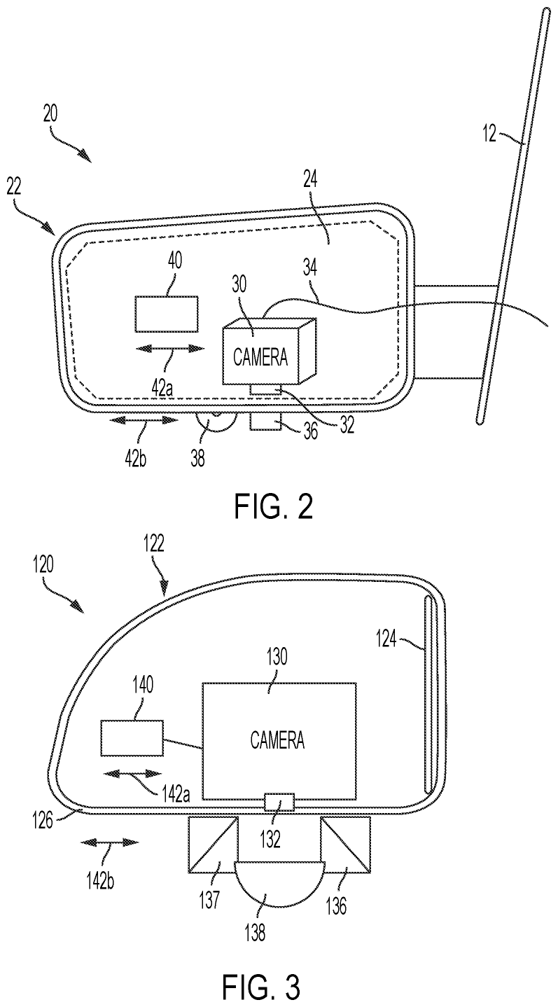

FIG. 2 shows a forward-facing view of a first imaging system 20. The first imaging system 20 includes a first exterior component of a vehicle in the form of a first exterior mirror housing 22. However, the first imaging system 20 may use a different exterior component, such as a different mirror housing, a trim piece, an applique, etc. The first exterior mirror housing 22 includes a mirror 24, which is shown in transparent to illustrate components that would typically be hidden behind the mirror 24. The first exterior mirror housing 22 also includes a first camera 30 having first integrated imaging components 32, such as one or more sensors, lenses, focusing mechanisms, etc. An electrical cable 34, such as a coaxial cable, is coupled to the first camera 30 to provide power to the first camera 34 and to transmit image data to a remote receiver.

The first imaging system 20 also includes a first optical element 36 and a second optical element 38, each providing a different field of view. The first optical element 36 includes a prism, which may provide a 90-degree reflection. The second optical element 38 includes a fisheye lens, which provides a greater FOV angle than what is provided by the first integrated imaging components 32 of the first camera 30, alone. The first imaging system 20 also includes a first actuator 40 configured to move the first camera 30 relative to the first optical element 36 and the second optical element 38. The first actuator 40 may include, for example, a motor or a solenoid. In some embodiments, the first actuator 40 may move the first camera 30, while the first and second optical elements 36, 38 remain stationary. For example, as shown in FIG. 2, the actuator 40 may move the first camera 30 along a first path 42a in a lateral direction, perpendicular to a forward direction of travel of the vehicle 10 (i.e., left and right). Alternatively, the actuator 40 may move the first and second optical elements 36, 38, while the first camera 30 remains stationary. For example, as shown in FIG. 2, the first actuator 40 may move the first and second optical elements 36, 38 along a second path 42b in a lateral direction (i.e., left and right).

The first actuator 40 may be electrically connected to the first camera 30, which can enable the electrical cable 34 to provide power and/or control signals thereto. Thus, the electrical cable 34 may serve both the first camera 30 and the first actuator 40. Alternatively, the first actuator 40 may be powered and/or controlled independently of the first camera 30.

FIG. 3 shows a side-facing view of a second imaging system 120. The second imaging system 120 includes an exterior component of a vehicle in the form of a second exterior mirror housing 122. However, the second imaging system 120 may use a different exterior component, such as a different mirror housing, a trim piece, an applique, etc. The second exterior mirror housing 122 includes a second mirror 124. The second exterior mirror housing 122 also includes a second camera 130 having second integrated imaging components 132, such as one or more sensors, lenses, focusing mechanisms, etc. The second camera 130 and the second integrated imaging components 132 may be similar or identical to the first camera 30 and the first integrated imaging components 32, respectively.

The second exterior mirror housing 122 includes a first lower surface 126 that is disposed parallel to the ground and faces downwardly. The second imaging system 120 also includes a third optical element 136, a fourth optical element 137, and a fifth optical element 138, each providing a different field of view. As shown in FIG. 3, each of the third optical element 136, the fourth optical element 137, and the fifth optical element 138 are located on the first lower surface 126 of the second exterior mirror housing 122. However, one or more of the third optical element 136, the fourth optical element 137, and the fifth optical element 138 may have a different physical location. For example, one or more third optical element 136, the fourth optical element 137, and the fifth optical element 138 may be at least partially located within the second exterior mirror housing 122. The third optical element 136 and the fourth optical element 137 each include a prism, which may provide a 90-degree reflection. The fifth optical element 138 includes a fisheye lens, which provides a greater FOV angle than what is provided by the second integrated imaging components 132 of the second camera 130, alone. The second imaging system 120 also includes a second actuator 140 configured to move the second camera 130 relative to the third, fourth, and fifth optical elements 136, 137, 138. The second actuator 140 may be similar or identical to the first actuator 40. In some embodiments, the second actuator 140 may move the second camera 130, while the third, fourth, and fifth optical elements 136, 137, 138 remain stationary. For example, as shown in FIG. 3, the second actuator 140 may move the second camera 130 along a third path 142a in a longitudinal direction, parallel to a forward direction of travel of the vehicle 10 (i.e., forward and rearward). Alternatively, the second actuator 140 may move the third, fourth, and fifth optical elements 136, 137, 138, while the second camera 130 remains stationary. For example, as shown in FIG. 3, the second actuator 140 may move the third, fourth, and fifth optical elements 136, 137, 138 along a fourth path 142b in a longitudinal direction (i.e., forward and rearward).

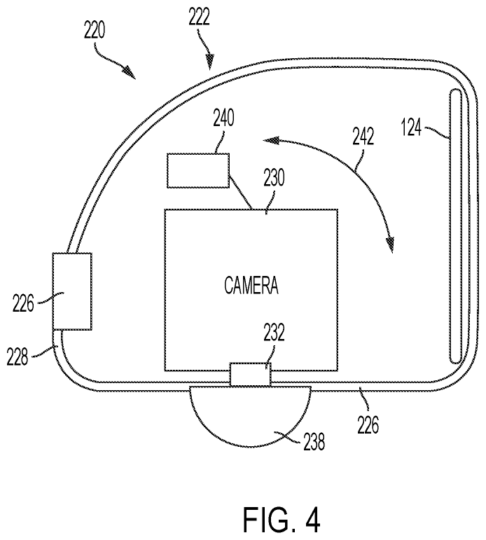

FIG. 4 shows a side-facing view of a third imaging system 220. The third imaging system 220 includes an exterior component of a vehicle in the form of a second exterior mirror housing 222. However, the third imaging system 220 may use a different exterior component, such as a different mirror housing, a trim piece, an applique, etc. The third exterior mirror housing 222 may be similar or identical to the second exterior mirror housing 122, with some differences described herein. The third exterior mirror housing 222 includes a third camera 230 having third integrated imaging components 232, such as one or more sensors, lenses, focusing mechanisms, etc. The third camera 230 and the third integrated imaging components 232 may be similar or identical to the second camera 130 and the second integrated imaging components 132, respectively.

The third exterior mirror housing 222 includes a second lower surface 226 that is disposed parallel to the ground and faces downwardly. The third exterior mirror housing 222 also includes a front surface 228 that faces forward, opposite from the second mirror 124 and perpendicular to the second lower surface 226.

The third imaging system 220 also includes a sixth optical element 236, and a seventh optical element 238, each providing a different field of view. As shown in FIG. 4, the sixth optical element 236 is located on the front surface 228 of the third exterior mirror housing 222. However, the sixth optical element 236 may have a different physical location. For example, the sixth optical element 236 may be at least partially located within the third exterior mirror housing 222. As also shown in FIG. 4, the seventh optical element 238 is located on the second lower surface 226 of the third exterior mirror housing 222. However, the seventh optical element 238 may have a different physical location. For example, the seventh optical element 238 may be at least partially located within the third exterior mirror housing 222.

The sixth optical element 236 may function as a window and may provide little to no lensing effects. For example, the sixth optical element 236 may include only a filter and/or physical protection for the third integrated imaging components 232 adjacent thereto. Alternatively, the sixth optical element 236 may provide a lensing effect. The seventh optical element 238 includes a fisheye lens, which provides a greater FOV angle than what is provided by the third integrated imaging components 232 of the third camera 230, alone.

The third imaging system 220 also includes a third actuator 240 configured to move the third camera 230 relative to the sixth optical element 236 and the seventh optical element 238. The third actuator 240 may move the third camera 230 along an arcuate path 242, while the sixth optical element 236 and the seventh optical element 238 remain stationary. For example, as shown in FIG. 4, the third actuator 240 may pivot or rotate the third camera 230 to cause the third integrated imaging components 232 to be selectively aligned with one of the sixth optical element 236 or the seventh optical element 238.

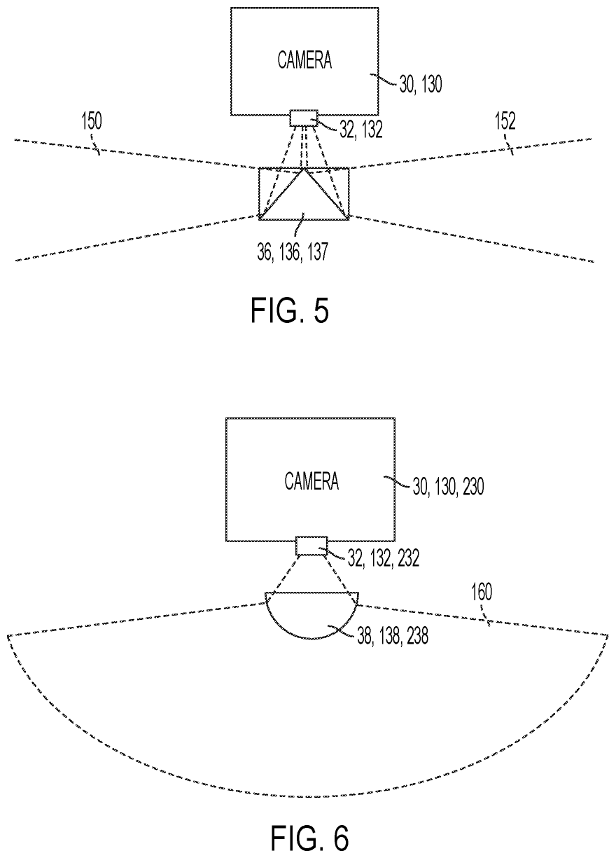

FIG. 5 shows a schematic diagram of a camera 30, 130 with a first FOV 150, 152, when the integrated imaging components 32, 132 are aligned with a prism-type optical element 36, 136, 137. A similar effect may be achieved by aligning the third integrated imaging components 232 of the third camera 230 with the sixth optical element 236. FIG. 6 shows a schematic diagram of a camera 30, 130, 230 with a second FOV 160 when the integrated imaging components 32, 132, 232 are aligned with a fisheye optical element 38, 138, 238.

In some embodiments, the imaging system 20, 120 of the present disclosure may be automatically adjusted in accordance with a vehicle speed of the vehicle 10. For example, in low speed modes, or standing still, the camera 30, 130 may be aligned with the FISHEYE element, in order to support the Surround view features during parking scenarios. At higher speeds, the camera 30, 130 is aligned with the PRISM optical elements in order to provide far range front and rear views to support object detection and tracking during high speed driving scenarios. Alternatively or additionally, the imaging system 20, 120 of the present disclosure may provide for a manual control for one of a plurality of different a camera views.

In some embodiments, the imaging system 20, 120 of the present disclosure may include the camera 30, 130, optical elements 36, 38, 136, 137, 138 and actuator 40, 140 that are integrated in a single housing as multi-function camera module. For example, the camera 30, 130, optical elements 36, 38, 136, 137, 138 and actuator 40, 140 may be mounted to a sub-structure (not shown in the FIGS.) that can be installed into a vehicle component. Alternatively, the camera 30, 130, optical elements 36, 38, 136, 137, 138 and actuator 40, 140 can each be discretely integrated in the mirror housing 22, 122.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An exterior vehicle component comprising:
a camera; and
a lens array including a first optical element and a second optical element, each providing a different field-of-view,
wherein at least one of the camera or the lens array is movable relative to the other one of the camera and the lens array to align the camera with a corresponding one of the first optical element or the second optical element, and
wherein the exterior vehicle component includes an exterior mirror.

2. (canceled)

3. The exterior vehicle component of claim 1, further comprising an actuator configured to move one of the camera or the lens array to align the camera with the corresponding one of the first optical element or the second optical element.

4. The exterior vehicle component of claim 3, wherein the actuator is configured to move the camera to align the camera with the corresponding one of the first optical element or the second optical element.

5. The exterior vehicle component of claim 3, wherein the actuator is configured to move the lens array to align the camera with the corresponding one of the first optical element or the second optical element.

6. The exterior vehicle component of claim 3, wherein the actuator is configured to move the one of the camera or the lens array in a lateral direction.

7. The exterior vehicle component of claim 3, wherein the actuator is configured to move the one of the camera or the lens array in a longitudinal direction.

8. The exterior vehicle component of claim 3, further comprising an electrical cable providing power to the camera; and wherein the electrical cable also provides at least one of electrical power or a control signal to the actuator.

9. The exterior vehicle component of claim 8, wherein the electrical cable includes a coaxial cable.

10. The exterior vehicle component of claim 1, wherein the corresponding one of the first optical element or the second optical element includes a fisheye lens.

11. The exterior vehicle component of claim 1, wherein the corresponding one of the first optical element or the second optical element includes a prism.

12. A system comprising the exterior vehicle component of claim 1, further comprising a controller configured to cause the camera to be aligned with a corresponding one of the first optical element or the second optical element based on a vehicle speed.

13. A system comprising the exterior vehicle component of claim 1, further comprising a controller configured to cause the camera to be aligned with a corresponding one of the first optical element or the second optical element based on a manual control input.

14. The exterior vehicle component of claim 3, wherein the actuator is configured to move the one of the camera or the lens array in an arcuate path.

15. The exterior vehicle component of claim 3, wherein the first optical element and the second optical element are disposed on different faces of the exterior vehicle component; and
wherein the actuator is configured to rotate the camera to align the camera with a corresponding one of the first optical element or the second optical element.

16. The exterior vehicle component of claim 1, further comprising:
an exterior mirror housing; and
a mirror, and
wherein the camera is disposed within the exterior mirror housing.

17. The exterior vehicle component of claim 16, wherein the exterior mirror housing includes a lower surface configured to be disposed parallel to a ground surface and facing downwardly, and
wherein at least a portion of the lens array is located on the lower surface of the exterior mirror housing.

18. An exterior vehicle component comprising:
a camera;
a lens array including a first optical element and a second optical element, each providing a different field-of-view; and
an actuator configured to move the camera to align the camera with a corresponding one of the first optical element or the second optical element.

19. The exterior vehicle component of claim 18, wherein the exterior vehicle component includes an exterior mirror.

20. The exterior vehicle component of claim 19, wherein the exterior vehicle component further includes:
an exterior mirror housing; and
a mirror, and
wherein the camera is disposed within the exterior mirror housing.

21. The exterior vehicle component of claim 20, wherein the exterior mirror housing includes a lower surface configured to be disposed parallel to a ground surface and facing downwardly, and
wherein at least a portion of the lens array is located on the lower surface of the exterior mirror housing.
